(19) United States
(12) Patent Application Publication
(10) Pub. No.: US 2006/0231125 A1
(43) Pub. Date: Oct. 19, 2006

(54) Apparatus and method for cleaning a semiconductor wafer

(75) Inventor: Hun-Jung Yi, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Suwon-Si (KR)

(21) Appl. No.: 11/377,963

(22) Filed: Mar. 17, 2006

(30) Foreign Application Priority Data
Apr. 13, 2005 (KR) 2005-30806

(51) Int. Cl. C23G 1/00; B08B 3/00; B08B 7/00

(52) U.S. Cl. 134/33; 134/95.2; 134/95.3; 134/149; 134/151; 134/26; 134/34; 134/2

(57) ABSTRACT

A cleaning apparatus is provided comprising a process chamber defining a work space, a supporter apparatus for rotating a wafer, the supporter apparatus being located in the work space and the wafer being mounted on the supporter apparatus such that a processing surface of the wafer is upwardly facing, an organic solvent supplying nozzle for supplying an organic solvent into the work space to the processing surface of the wafer mounted on the supporter apparatus, and a dry gas supplying nozzle for supplying an organic solvent vapor into the work space and forming an organic solvent atmosphere therein. Thus, water remaining on the wafer may be readily removed.

### CROSS-REFERENCE TO RELATED APPLICATIONS

This U.S. non-provisional patent application claims priority under 35 U.S.C. § 119 from Korean Patent Application 2005-30806 filed on Apr. 13, 2005, the entire contents of which are hereby incorporated by reference.

### BACKGROUND

1. Field of the Invention

The present invention relates to an apparatus and a method for manufacturing a semiconductor device. More particularly, the present invention relates to an apparatus and a method for cleaning a semiconductor wafer.

2. Discussion of the Related Art

In general, a semiconductor wafer is manufactured by repeatedly performing various manufacturing processes such as a deposition process, a development process, an etch process, a cleaning process and etc. The cleaning process is for removing residual chemicals, small particles, contaminants, or unnecessary films on a surface of the semiconductor wafer, which are produced during the manufacturing processes. With recent trends of patterns on the semiconductor wafer being smaller, the cleaning process becomes more important.

The cleaning process for the semiconductor wafer includes a cleaning step for etching or dissembling the contaminants on the surface of the semiconductor wafer by wet chemical reactions, a rinsing step for rinsing the semiconductor wafer with deionized water after the chemical treatment, and a drying step for drying the semiconductor wafer after the rinsing step.

In early days of the semiconductor wafer manufacturing, a spin dryer was used for the drying step, wherein the semiconductor wafer was placed with the surface to be process facing upward, and the drying step was carried out by a centrifugal force. An example of the spin dryers has been disclosed in U.S. Pat. No. 5,829,156. However, as structures of the semiconductor chips increase the complexity thereof, the spin dryer showed limitations in that tiny water droplets on the wafer surface were not completely removed by the spin dryer, but the contaminants aggregated in the tiny water droplets are remained on the wafer surface. In addition, since the spin dryer is rotated at a high speed, a vortex occurs at the wafer surface, thereby applying the contaminants and mechanical stress on the semiconductor wafer.

To avoid the limitations or problems of the spin dryer, a multi-wafer dryer has been widely used. The multi-wafer dryer has a process chamber into which about 50 wafers are received simultaneously. For the drying process of the multi-wafer dryer, the chemicals and the deionized water are sequentially provided into the chamber for chemically treating and rinsing the wafer. Next, the rinsed wafer is dried by a Marangoni effect where an isopropyl alcohol layer is formed on a surface of the deionized water. An example of an apparatus for drying the wafer using the Marangoni effect has been disclosed in Japan Laid Open Patent Application No. 10-335299. However, since a group of wafers is substantially simultaneously dried in the multi-wafer dryer, contaminants remain in the chamber after the drying process is finished. These contaminants contaminate a next group of wafers transferred into the chamber for the drying process. This problem is especially serious with the multi-wafer dryer that uses a single chamber for the chemical treatment process, the rinsing process, and the drying process.

Due to the problems of the multi-wafer dryer aforementioned, the single-wafer dryer is recently in use again, wherein the wafer is rotated with its surface to be processed facing upward, and an isopropyl alcohol vapor is provided onto a center region of the wafer. In the multi-wafer dryer, the wafers are positioned vertically in the process chamber. Therefore, a meniscus layer formed between the wafer and the deionized water is uniformly maintained, since a liquid flow is inducted by gravity on the surfaces of the wafers that are vertically aligned. In the single-wafer dryer, however, the liquid flow on the wafer surface is inducted by the centrifugal force not by the constant gravitational force. Therefore, the meniscus layer tends to be unstable, resulting poor drying, and the deionized water within a fine structure such as a contact hole is not easily removed with the single-wafer dryer. When the wafer in the single-wafer dryer is rotated at a slower speed, the aforementioned problems can be reduced, but a process time of the drying is lengthened.

In the single-wafer dryer, the isopropyl alcohol vapor generated outside the process chamber is supplied to a nozzle with a carrier gas such as a nitrogen gas. Therefore, the concentration of the isopropyl alcohol vapor is lowered, so that drying efficiency is also lowered. Another problem with the single-wafer dryer is that local dry spots are formed easily on the wafer surface. That is, when a diameter of the wafer becomes large, the peripheral region of the wafer dries even before the wafer is dried by the isopropyl alcohol vapor. When the wafer is cleaned by some chemicals like hydrofluoric acid, the wafer surface becomes hydrophobic, thereby forming local dry spots.

### SUMMARY

In one aspect of the present invention, a cleaning apparatus is provided which comprises a process chamber defining a work space. A supporter apparatus for rotating a wafer is located in the work space and a wafer is mounted on the supporter apparatus such that a processing surface of the wafer is upwardly facing. An organic solvent supplying nozzle is also provided for supplying an organic solvent into the work space to the processing surface of the wafer mounted on the supporter apparatus. A dry gas supplying nozzle for supplying an organic solvent vapor into the work space and forming an organic solvent atmosphere therein is part of the cleaning apparatus. The organic solvent can comprise an isopropyl alcohol

The process chamber, in one embodiment, comprises a container in which the supporter apparatus is located, the container having an opening at an upper portion thereof. It also includes a lid for receiving the dry gas supplying nozzle and for opening or closing the opening of the container, and a porous plate, positioned between the lid and the container, for distributing the dry gas supplied from the dry gas supplying nozzle into the container. The cleaning apparatus can further comprise a rinsing nozzle mounted on the supporter apparatus for supplying a rinsing liquid onto the processing surface of the wafer.

The organic solvent supplying nozzle can comprise a total region supplying nozzle for supplying the organic solvent substantially to the total processing surface of the wafer extending from a center region to a peripheral region. In another embodiment, the total region supplying nozzle supplies the organic solvent simultaneously to the total processing surface of the wafer extending from a center region to a peripheral region. In one embodiment, the total region supplying nozzle comprises a slit or a plurality of holes for spraying the organic solvent. In another embodiment, the organic solvent supplying nozzle comprises a center region supplying nozzle for supplying the organic solvent only to the center region of the wafer.

In a further embodiment, the cleaning apparatus further comprising a heater for heating the wafer mounted on the supporter apparatus. In another embodiment, the heater is a lamp that is located outside the process chamber. In still another embodiment, the cleaning apparatus further comprises a lamp for heating the wafer mounted on the supporter apparatus. Moreover, the lid comprises a lower plate into which the dry gas supplying nozzle is installed, and an upper plate disposed on the lower plate to receive the lamp therein. In one embodiment, the lamp has a ring-shape or a rod-shape. In another embodiment, the heater comprises at least one lamp located outside the container. The dry gas supplying nozzle can be connected to a vapor supplier for supplying the organic solvent in a vapor state and to a gas supplier for supplying an inert gas.

In an embodiment herein, the cleaning apparatus can further comprise a controller for controlling an amount of the organic solvent supplied from the organic solvent supplying nozzle such that a volume concentration of the organic solvent in a mixture of the organic solvent and cleaning chemicals on the processing surface of the wafer is greater than a volume concentration of the organic solvent in an azeotropic mixture. This mixture is at a temperature above the boiling point of the mixture.

In another embodiment, the cleaning apparatus comprises the process chamber defining a work space and the supporter apparatus described above. It also includes a total region supplying nozzle for supplying an organic solvent to a total processing surface of the wafer extending from a center region to a peripheral region. In a further embodiment, the cleaning apparatus also comprises a heater for heating the wafer mounted on the supporter apparatus, and a controller as described above.

A cleaning method of an embodiment herein comprises providing a processing chamber defining a work space, loading a wafer on a supporter apparatus located in the work space such that a processing surface of the wafer is upwardly facing, introducing an organic solvent in a vapor state into the process chamber forming a drying atmosphere in the work space, and directing the organic solvent vapor onto the processing surface of the wafer while substantially simultaneously rotating the wafer. In one embodiment, the providing of the organic solvent onto the processing surface of the wafer comprises providing the organic solvent substantially simultaneously to a total processing surface of the wafer from a center region to a peripheral region. In another embodiment, the providing of the organic solvent directly onto the processing surface of the wafer further comprises providing the organic solvent only to the center region of the wafer. Still another embodiment further comprises heating the wafer, wherein the organic solvent is provided onto the wafer surface from the organic solvent supplying nozzle such that a volume concentration in a mixture of the organic solvent and cleaning chemicals on the processing surface of the wafer is larger than a volume concentration of the organic solvent in an azeotropic mixture, the mixture being heated above the boiling point of the mixture.

The cleaning method can also comprise, prior to providing the organic solvent into the work space for the drying atmosphere, supplying an inert gas into the work space to remove oxygen in the process chamber. Moreover it can further comprise, prior to providing the organic solvent into the work space for the drying atmosphere, supplying an inert gas and an alcohol vapor into the work space to remove oxygen in the process chamber.

According to the above, the drying process is carried out while the processing chamber is in the organic solvent atmosphere, and thus the surface tension of the deionized water on the wafer may be greatly reduced, thereby easily removing the deionized water from the wafer.

Further, the organic solvent atmosphere in the container, the concentration of the organic solvent on the entire surface of the wafer and the temperature of the wafer may be controlled using the controller, thereby enhancing the drying efficiency and reducing the process time required to dry the wafer.

### BRIEF DESCRIPTION OF THE DRAWINGS

The above and other features of the present invention will become more apparent to those of ordinary skill in the art by describing in detail preferred embodiments thereof with reference to the attached drawings in which:

FIG. 1 is a sectional view illustrating a cleaning apparatus according to an exemplary embodiment of the present invention;

FIG. 2 is a sectional view taken along a line A-A′ of FIG. 1;

FIG. 3 is a perspective view illustrating an example of a total region supplying nozzle of FIG. 1;

FIG. 4 is a perspective view illustrating another example of a total region supplying nozzle of FIG. 1;

FIG. 5 is a plan view illustrating an example of a heater of FIG. 1;

FIG. 6 is a plan view illustrating another example of a heater of FIG. 1;

FIG. 7 is a graph describing evaporation characteristics of isopropyl alcohol and water mixtures;

FIG. 8 is a flow chart illustrating a drying method of a wafer according to an exemplary embodiment of the present invention; and

FIGS. 9 to 13 are sectional views illustrating states of a process chamber to which a drying process is applied.

### DETAILED DESCRIPTION

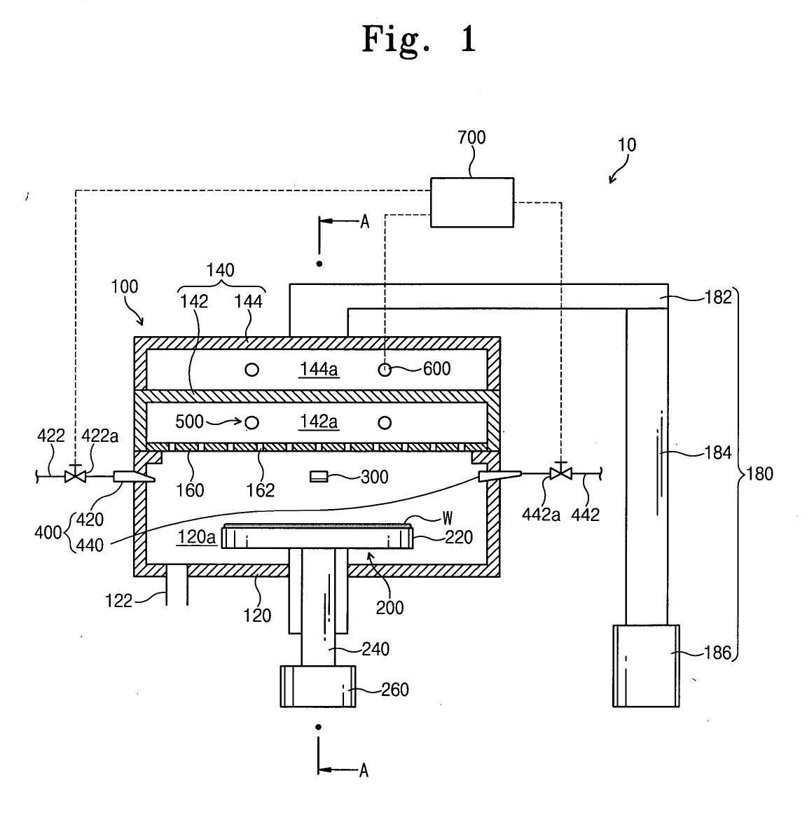

Hereinafter, the embodiments of the present invention will be described below in more detail with reference to the accompanying drawings, FIGS. 1 to 13. The present invention may, however, be embodied in different forms and should not be constructed as limited to the embodiments set forth herein. Rather, these embodiments are provided so that this disclosure will be thorough and complete, and will fully convey the scope of the invention to those skilled in the art.

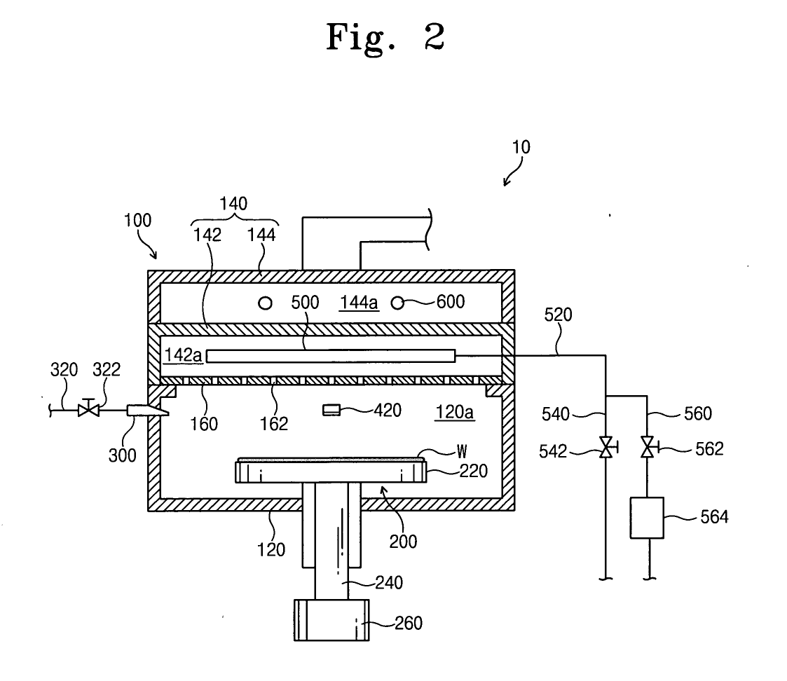

Referring to FIGS. 1 and 2, the cleaning apparatus 10 includes a process chamber 100, a supporter apparatus 200, a rinsing nozzle 300, an organic solvent supplying nozzle 400, a dry gas supplying nozzle 500 and a heater 600.

The process chamber 100 defines a work space for a cleaning process. The process chamber 100 includes a container 120 and a lid 140. The container 120 has an inner space 120a therein with an opening at its top. An exhaust line 122 is connected to a bottom of the container 120 to exhaust chemical liquids and rinsing liquids. The lid 140 is to open or close the opening at the top of the container 120. The lid 140 includes an upper plate 144 and a lower plate 142. The upper plate 144 is positioned above the lower plate 142 and fixed to the lower plate 142. The upper plate 144 and the lower plate 142 include inner spaces 144a and 142a, respectively, having an opening at its bottom. A device 180 is provided for moving the lid 140. The moving device 180 includes a supporting arm 182 coupled to the upper plate 144 of the lid 140 and a moving rod 184 for moving the supporting part 182. The supporting arm 182 is typically elongated in the horizontal direction, while the moving rod 184 is typically elongated in the vertical direction. The moving rod 184 is coupled to an end of the supporting part 182. An actuator 186 is coupled to the moving rod 184 to rotate or vertically move the moving rod 184. A sealing device (not shown) such as an O-ring may be installed between the lid 140 and the container 120 in order to seal the process chamber 100 when the container 120 is closed using the lid 140.

The supporter apparatus 200 supports a semiconductor substrate such as a wafer (W) during the process. The supporter apparatus 200 includes a supporting plate 220 and a rotating axle 240. The supporting plate 220 is typically a circular plate with a flat upper surface having a diameter which is similar to that of the wafer (W). The wafer (W) is mounted on the supporting plate 220 such that a processing surface of the wafer (W) upwardly faces. The rotating axle 240 is fixed to the bottom of the supporting plate 220. The rotating axle 240 is rotated by a driving device 260 such as a motor. A lift pin (not drawn here) may be installed on the supporter apparatus 200 to take the wafer (W) from a transferring robot (not shown) that transfers the wafer (W) to the process chamber 100 and load the wafer (W) on the supporting plate 220. During the process, the supporting plate 220 may support the wafer (W) using various methods such as a vacuum suction, a mechanical clamping, etc. As another method, a plurality of guide pins (not drawn here) may be installed on the peripheral region of the supporting plate 240, thereby preventing separation of the wafer (W) from the supporting plate 220 during the process.

The cleaning apparatus 10 includes a chemical supplying nozzle (not drawn here) for chemical cleaning process and a rinsing nozzle 300 for rinsing process. The chemical supplying nozzle provides the chemicals to the wafer (W) in order to etch or separate the contaminants on the wafer surface by chemical reactions. The rinsing nozzle 300 provides the rinsing liquids to the wafer (W) in order to remove residual chemicals on the wafer (W). The cleaning apparatus 10 may include a plurality of chemical supplying nozzles to supply various chemicals to the wafer (W) in consideration of chemical properties of the contaminants. In the exemplary embodiment, as one of the rinsing liquids, deionized water is used for the cleaning apparatus 10. The chemical supplying nozzle and the rinsing nozzle 300 are installed in the container 120 such that the chemicals and the rinsing liquids are sprayed to a center of the wafer (W). While the chemicals or the rinsing liquids are sprayed, the wafer (W) is in rotation and the chemicals or the rinsing liquids are spread from the center to the peripheral region of the wafer (W).

For the drying process, the cleaning apparatus 10 includes an organic solvent supplying nozzle 400, a drying gas supplying nozzle 500, and a heater 600. An isopropyl alcohol and a nitrogen gas can be used as an organic solvent and an inert gas. An example of the organic solvent in lieu of the isopropyl alcohol may include various materials that have a low surface tension and are soluble to the rinsing liquids, such as ethyl glycol, 1-propanol, 2-propanol, tetrahydrofurane, 4-hydroxy-4-methyl-2-pentamone, 1-butanol, 2-butanol, methanol, ethanol, acetone, n-propyl alcohol, or dimethylether, etc. The inert gas also may comprise various gases that are chemically stable in lieu of the nitrogen gas.

The organic solvent supplying nozzle 400 provides the isopropyl alcohol directly to the wafer (W) to dry the wafer after the rinsing process is finished. Also, the organic solvent supplying nozzle 400 may provide the wafer (W) with a high concentration of the isopropyl alcohol vapor. The isopropyl alcohol reduces the surface tension of the deionized water on the surface of the wafer (W) to readily remove the deionized water from the wafer (W). That is, the deionized water is removed from the surface of the wafer (W) due to the Marangoni effect using the surface tension difference between the isopropyl alcohol and the deionized water.

The organic solvent supplying nozzle 400 includes a center region supplying nozzle 420 and a total region supplying nozzle 440. Supply lines 422 and 442 for supplying the isopropyl alcohol are connected to the center region supplying nozzle 420 and the total region supplying region nozzle 440, respectively. Flow rate control valves 422a and 442a for controlling a flow rate of discharge inside the supply lines 422 and 442 are installed to the supply lines 422 and 442, respectively.

The center region supplying nozzle 420 is installed on a side wall of the container 120 and provides the isopropyl alcohol only to the center of the wafer (W). The isopropyl alcohol provided to the center of the wafer (W) flows from the center of the wafer (W) to the peripheral region of the wafer (W) due to the centrifugal force as the wafer (W) is rotated. When the isopropyl alcohol is supplied only to the center region, the peripheral region of the wafer (W) are dried by the centrifugal force in early period of the drying process and water spots are easily formed in the peripheral region. Further, the isopropyl alcohol is insufficiently supplied to the peripheral region of the wafer (W), since the isopropyl alcohol starts to spread from the center of the wafer (W) to the peripheral region of the wafer (W).

In the exemplary embodiment of the present invention, the total region supplying nozzle 440 is installed on the side wall of the container 120, and provides the isopropyl alcohol simultaneously to the total surface corresponding to the center region and the peripheral region of the wafer (W). The total region supplying nozzle 440 is arranged in the vertical direction and coupled to the container 120.

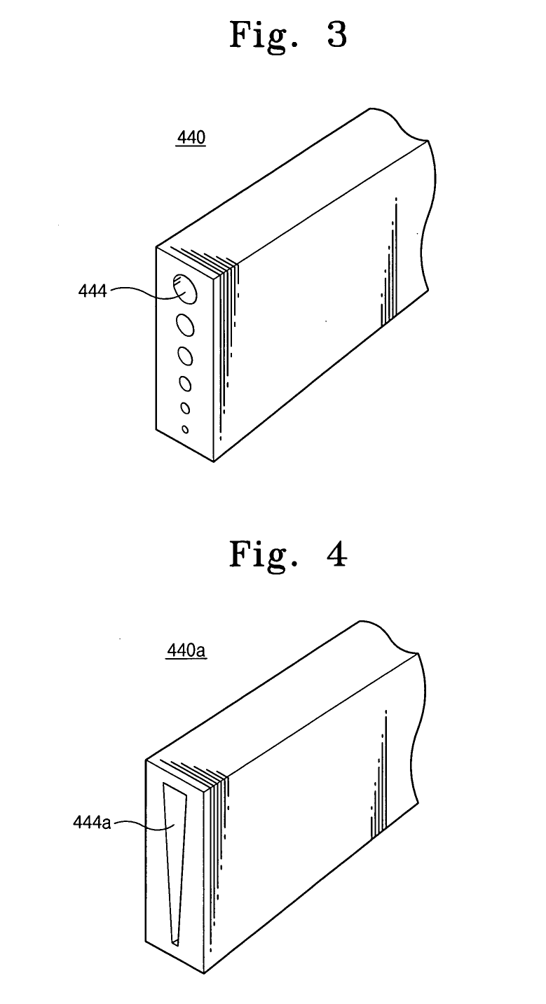

Referring to FIG. 3, the total region supplying nozzle 440 has an injection nozzle through which a plurality of circular holes 444 is formed. The plurality of circular holes 444 can be arranged in a vertical direction. The isopropyl alcohol may be supplied to the center region of the wafer (W) through an uppermost circular hole among the circular holes 444 and the isopropyl alcohol may be supplied to the peripheral region of the wafer (W) through a lowermost circular hole among the circular holes 444.

Sizes of the circular holes 442 and distances between the circular holes 444 can be determined in a variety of ways such that a desired amount of the isopropyl alcohol is provided to the corresponding region of the wafer (W). Also, the sizes of the circular holes 444 can be increasingly larger with respect to the height of its center location. In accordance with this arrangement, the amount of the isopropyl alcohol becomes increasingly large from the peripheral region to the center region of the wafer (W), and finally the isopropyl alcohol is distributed uniformly over an entire surface of the wafer (W). The distances between the circular holes 444 may be same as or different from each other according to the process conditions.

Referring to FIG. 4, a total region supplying nozzle 440a may have an injection slit 444a that is vertically elongated. The slit 444a has a width that becomes increasingly large from a bottom to a top of the slit 444a such that an amount of the isopropyl alcohol provided to the wafer (W) is gradually increased with the height of the slit 444a.

Contrary to the embodiments described in detail above, the circular holes 444 may have a same size as each other, and the slit 444a may have a constant width. Contrary to the embodiments aforementioned, the total region supplying nozzle 440 can also be arranged long in a horizontal direction.

The dry gas supplying nozzle 500 of FIGS. 1 and 2 is installed in the inner space 142a of the lower plate 142. The dry gas supplying nozzle 500 introduces the dry gas into the container 120. The dry gas may include the isopropyl alcohol vapor and nitrogen gas. The isopropyl alcohol vapor is used to allow the container 120 to have a drying atmosphere for the drying process. The isopropyl alcohol vapor can be supplied to the container 120 using the carrier gas such as nitrogen. The nitrogen gas can also be used to remove oxygen from the container 120 before the container 120 has the drying atmosphere. In addition, a heated nitrogen gas can be used to remove the residual isopropyl alcohol on the surface of the wafer (W).

The dry gas supplying nozzle 500 is connected to a vapor supplying line 540 and a gas supplying line 560 (see FIG. 2). The vapor supplying line 540 is for supplying the isopropyl alcohol vapor, and the gas supplying line 560 is for supplying the nitrogen gas. Valves 542 and 562 are installed at the vapor supplying line 540 and the gas supplying line 560, respectively, to close or open the vapor supplying line 540 and the gas supplying line 560 and to control the flow rate of discharge. According to an exemplary embodiment of the present invention, a main supplying line 520 is connected to the dry gas supplying nozzle 500, and the main supplying line 520 branches into the vapor supplying line 540 and the gas supplying line 560. A heater 564 is installed at the gas supplying line 560.

According to an embodiment of the present invention, two dry gas supplying nozzles are juxtaposed to each other. The dry gas supplying nozzles 500 can have an elongate shape. The dry gas supplying nozzle 500 has one or more injection nozzles. The injection nozzle may be a plurality of circular holes or a slit. Sizes of the circular holes and/or the distances between the circular holes may be uniform or non-uniform. Alternatively, the sizes of the circular holes may become increasingly large, or the distances between the circular holes may be decreasingly small as the circular holes is further spaced apart from the supplying line.

A porous plate 160 is installed at the bottom of the lower plate 142. The porous plate 160 has a generally circular shape, and divides the inner space 142a of the lower plate 142 from the inner space 120a of the container 120. A plurality of the penetrating holes 162 are formed through the porous plate 160 and the penetrating holes 162 are distributed uniformly and densely over the porous plate 160. The dry gas supplied to the inner space 142a of the lower plate 142 from the dry gas supplying nozzle 500 is injected into the container 120 through the porous plate 160. Hence, the dry gas can be uniformly supplied into an entire inner space of the container 120.

In the exemplary embodiments aforementioned, the gas for purging the container 120, the gas for the drying atmosphere of the container 120 and the gas for removing the residual alcohol from the wafer (W) are all supplied through the dry gas supplying nozzle 500. However, the gas for purging the container 120, the gas for the drying atmosphere of the container 120 and the gas for removing the residual alcohol on the surface of the wafer (W) may be provided separately.

A heater 600 is installed in the inner space 144a of the upper plate 144 of the lid 140. The heater 600 removes the residual deionized water within the fine structures of the wafer patterns using an azeotrope mixture effect. The azeotrope mixture effects and the necessary process conditions to accomplish the effects will be described later. Lamps, placed outside the container 120 are used as the heater 600 to prevent explosion of the organic solvent by the heater 600.

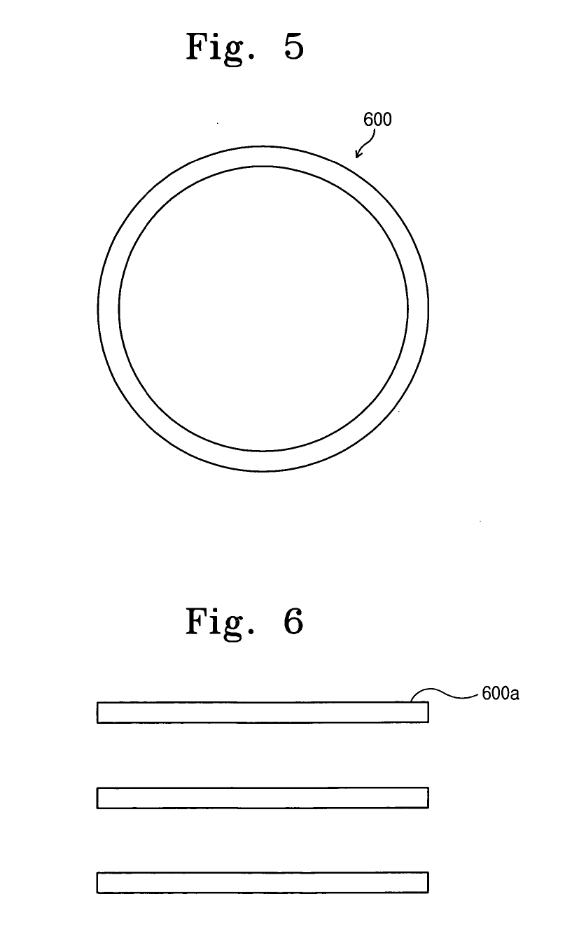

Referring to FIG. 5, the lamp 600 has a circular ring shape. Depending on a size of the wafer (W), one or more lamps can be used for the cleaning apparatus 10 such that the entire surface of the wafer (W) is uniformly heated. When one lamp 600 is used for the cleaning apparatus 10, the lamp 600 can have a diameter of about a half of a diameter of the wafer (W).

According to FIG. 6, the lamp 600 may have a linear rod-like shape. Similarly, one or more lamps can be used for the cleaning apparatus 10 depending on the size of the wafer (W), and the lamp 600 has a length similar with the diameter of the wafer (W). When the lamps are employed for the cleaning apparatus 10, the lamps are juxtaposed to each other and uniformly spaced apart from each other.

The described structures of the cleaning apparatus 10, such as the structure of the lid 140, the locations of the dry gas supplying nozzle 500 and the heater 600, the number and shape of the dry gas supplying nozzle 500 and the heater 600, etc., may be variable according to the sizes or the shapes of the process chamber 100 and the wafer (W). For example, the lid 140 may be formed in a single plate, the dry gas supplying nozzle 500 may be inserted into the container 120 through the side wall of the container 120, and the lamp 600 may be installed inside the supporter apparatus 200.

Hereinafter, the process conditions for removing the residual deionized water within the fine structures of the wafer patterns by the azeotrope mixture effect will be described. In the exemplary embodiment, the isopropyl alcohol and the water are used as the organic solvent and the rinsing liquid, respectively.

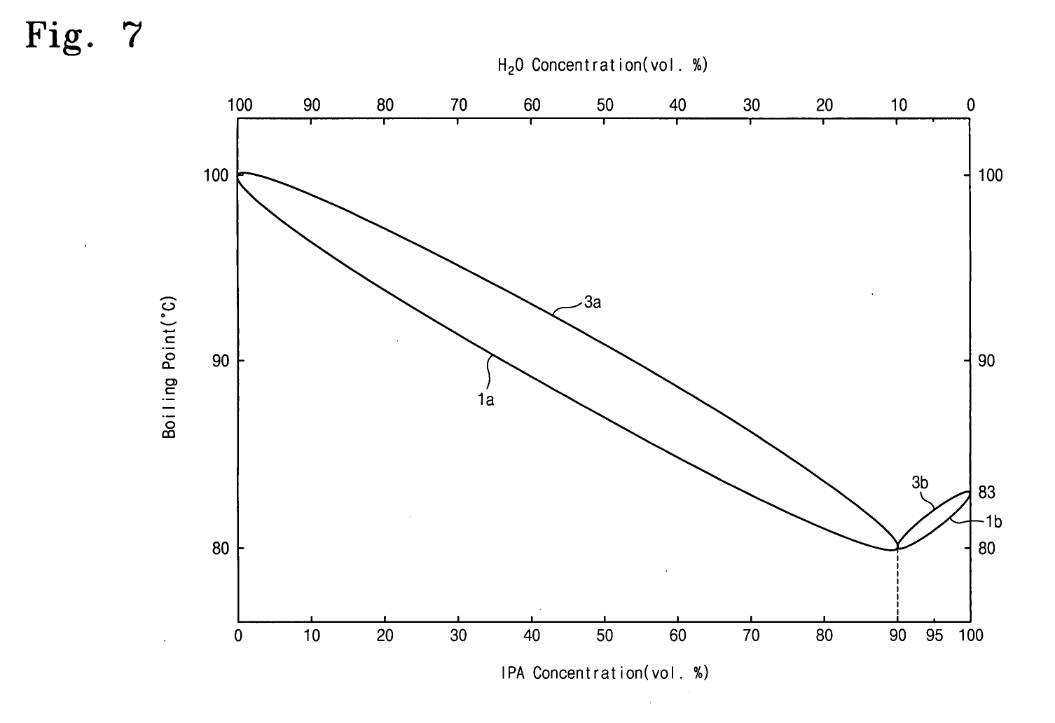

Referring to FIG. 7, an isopropyl alcohol solution is a mixture of isopropyl alcohol and water. In FIG. 7, an abscissa denotes a volume concentration of the isopropyl alcohol solution and an ordinate denotes a boiling point of the isopropyl alcohol solution. The first group of curves 1a and 1b shows the boiling point of the isopropyl alcohol solution, and the second group of curves 3a and 3b shows the evaporation point of the isopropyl alcohol solution.

Referring to FIG. 7, an azeotrope mixture of the isopropyl alcohol solution is a mixture of about 10 Vol. % of the water and 90 Vol. % of the isopropyl alcohol, and the boiling point of the azeostrope mixture of the isopropyl alcohol solution (IPA azeostrope mixture) is about 80 degrees C. When the IPA azeotrope mixture is evaporated, the concentration of the evaporated isopropyl alcohol is the same as that of the IPA azeotropic mixture. However, when the isopropyl alcohol solution is evaporated, the volume concentration of the isopropyl alcohol being larger or smaller than 90 Vol. %, the concentration of the evaporated isopropyl alcohol is different from that of the IPA azeotropic mixture. This is because the boiling point of the isopropyl alcohol solution is lower than its evaporation point, when the volume concentration of the isopropyl alcohol is larger or smaller than 90 Vol. % as shown in FIG. 7.

For example, when the isopropyl alcohol solution of the volume concentration of 50 Vol. % reaches the boiling point (the curve 1a), the isopropyl alcohol solution begins to boil. Here, more of the isopropyl alcohol than the water evaporates. Hence, the volume concentration of the isopropyl alcohol in the isopropyl alcohol solution becomes lower than 50 Vol. %.

For another case, when the isopropyl alcohol solution of the volume concentration is between 90 Vol. % and 100 Vol. %, particularly when the isopropyl alcohol solution of 95 Vol. % reaches to the boiling point on the curve 1a, the isopropyl alcohol solution also starts to boil. However, in this case, more of the water evaporates than the isopropyl alcohol. Hence, the volume concentration of the water in the isopropyl alcohol solution becomes less than 5 Vol. %.

The cleaning apparatus 10 further includes a controller 700. Controller 700 can increase the evaporation rate of the residual water within the fine structures of the wafer patterns by the azeotropic mixture effect as aforementioned. The controller 700 can control the amount of the organic solvent that is supplied to the wafer (W) from the organic solvent supplying nozzle 400 and also can control the heating rate by the lamp 600. The controller 700 can control the flow rate control valves 422a and 442a respectively installed at the supply lines 422 and 442 through which the isopropyl alcohol is supplied to the center region supplying nozzle 420 or to the total region supplying nozzle 440. The controller 700 can provide a sufficient amount of the isopropyl alcohol to the wafer (W) such that the volume concentration of the isopropyl alcohol solution on the surface of the wafer (W) is greater than 90 Vol. %. The controller 700 can also control the lamp 600 allowing the residual isopropyl alcohol solution on the surface of the wafer (W) to be heated at a higher temperature than its boiling point.

The controller 700 may further include a sensor (not drawn here) for sensing on real time base the concentration or the temperature of the residual isopropyl alcohol solution on the surface of the wafer (W). The controller 700 may also control the amount of isopropyl alcohol provided to the wafer (W) or the heat amount from the lamp 600 using the sensed data. Before the cleaning process starts, the amount of isopropyl alcohol provided to the wafer (W) or the heat amount from the lamp 600 may be set using the controller 700 based on experimental results.

According to the exemplary embodiment of the present invention, the volume concentration of the isopropyl alcohol in the isopropyl alcohol solution can be maintained to be high enough at the entire surface of the wafer (W) including the inside of the fine structures of the wafer patterns since the isopropyl alcohol is directly supplied not only to the center region of the wafer (W) through the center region supplying nozzle 420, but also to the entire surface of the wafer (W) through the total region supplying nozzle 440.

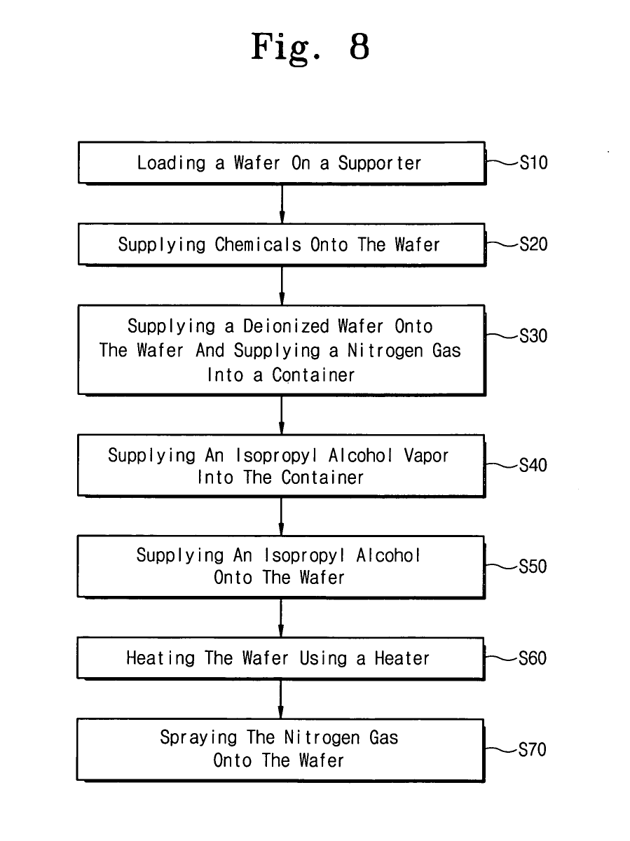

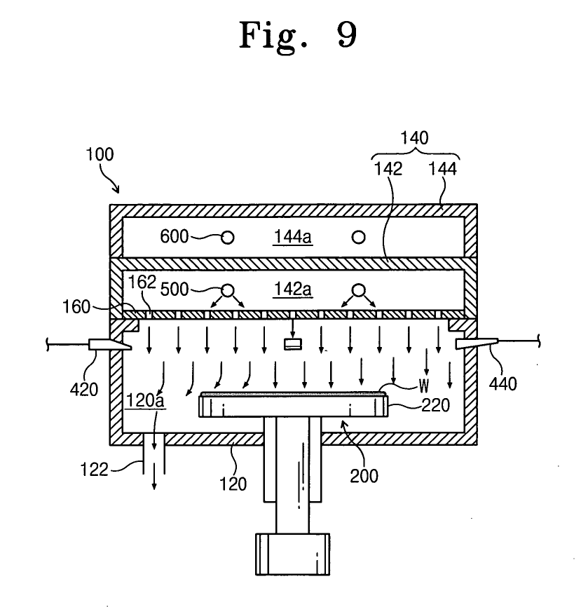

FIG. 8 is a flow chart illustrating a drying method according to an exemplary embodiment of present invention. FIGS. 9 to 13 are sectional views illustrating, respectively, the states of the process chamber 100 at each step during the drying process. In the exemplary embodiment, as the organic solvent and the inert gas, isopropyl alcohol and nitrogen gas are used, respectively.

Referring to FIG. 9, the lid 140 is open such that the top of the container 120 is open, and then the wafer (W) is mounted on the supporter apparatus 200 in the process chamber 100 by the transferring robot (step S10). When the wafer (W) is rotated and the chemicals are supplied to the center region of the wafer (W) through the chemical nozzle, the contaminants on the surface of the wafer (W) are removed (step S20). Depending on the location of the chemical nozzle, the top of the container 120 is open or closed by the lid 140. Then, the deionized water is supplied to the center region of the wafer (W) through the rinsing nozzle 300 to remove the residual chemicals on the surface of the wafer (W) (step S30).

As shown in FIG. 9, before the drying process starts, the inside of the container 120 is purged by supplying nitrogen gas into the container 120 (step S30). This serves to remove the oxygen from the container 120 and prevent process defects caused by the oxygen during the drying process. The purge process of the container 120 is carried out while the wafer (W) is rinsed, so that a process time required for cleaning the wafer (W) may be reduced. Also, the nitrogen gas and the isopropyl alcohol vapor may be substantially simultaneously used for purging the container 120.

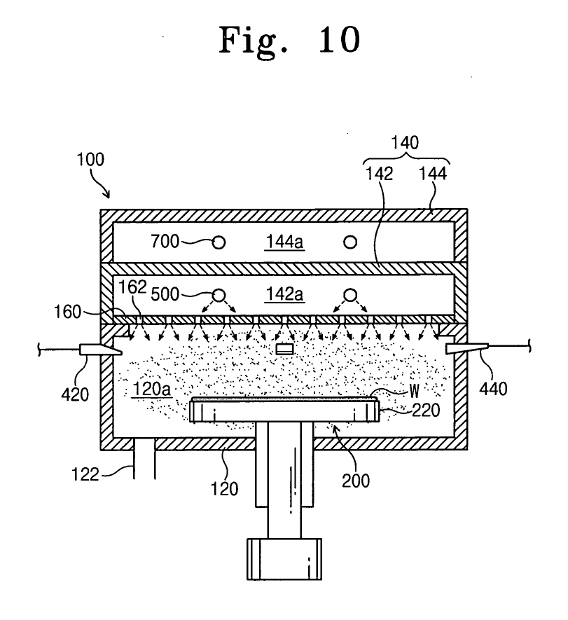

After the purging process of the container 120 is finished, as shown in FIG. 10, the isopropyl alcohol vapor is supplied into the container 120 such that the inside of the container 120 has a drying atmosphere for the drying process (step S40). Due to the isopropyl alcohol vapor supplied into the container 120, the surface tension of the deionized water is reduced, thereby removing the residual deionized water easily from the wafer (W).

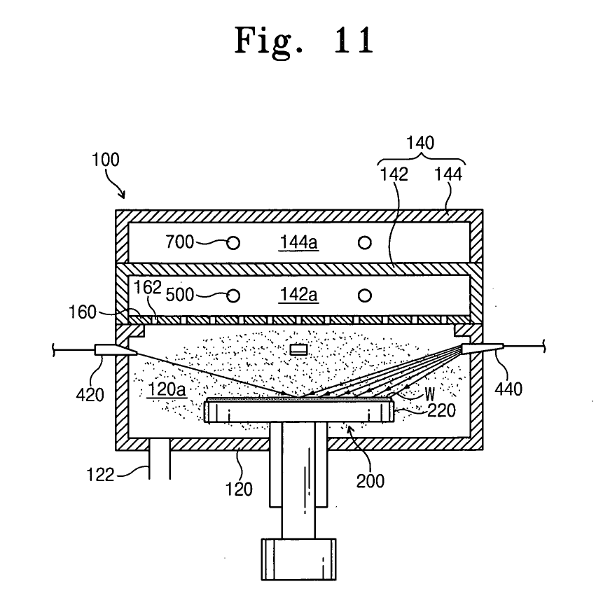

After the inside of the container 120 is in the drying atmosphere mode for the drying process, as shown in FIG. 11, the isopropyl alcohol is provided to the center region of the wafer (W) from the center region supplying nozzle 420, and substantially simultaneously to the entire wafer (W) from the center region to the peripheral region of the wafer (W) by the total region supplying nozzle 440 (step S50) while the wafer (W) is rotated, to thereby dry the wafer (W).

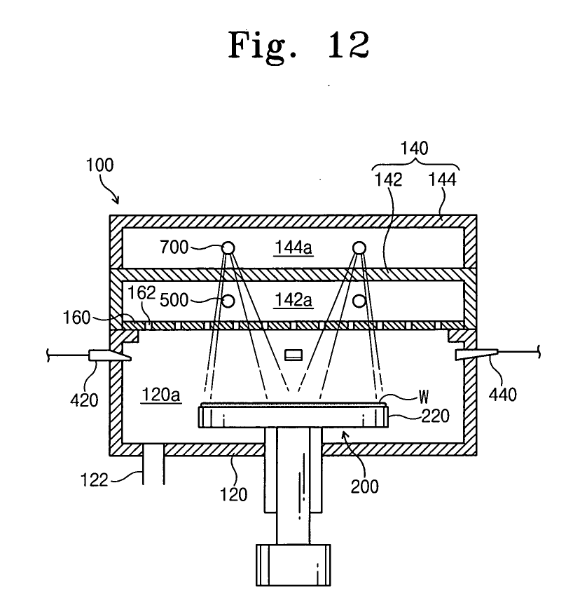

As shown in FIG. 12, when the volume concentration of the isopropyl alcohol of the isopropyl alcohol solution on the surface of the wafer (W) is larger than that of the IPA azeotrope mixture, the wafer is heated by the lamp 600 such that the isopropyl alcohol solution is heated at the higher temperature than its boiling point (step S60).

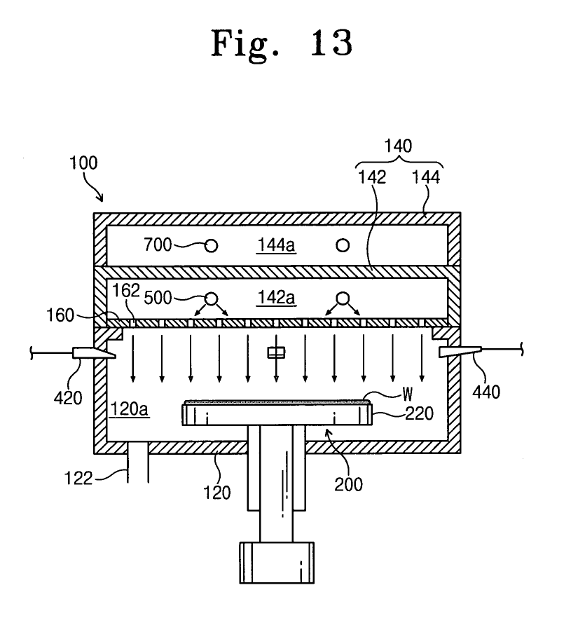

When the drying process by isopropyl alcohol is finished, as shown in FIG. 13, the heated nitrogen gas is sprayed onto the wafer (W) (step S70) to evaporate the residual isopropyl alcohol on the surface of the wafer (W).

Table 1 below represents a relative amount between the residual water on the surface of the wafer (W) by the cleaning apparatus 10 of the present invention and the residual water on the surface of the wafer by a conventional cleaning apparatus. In Table 1, “A” refers to the cleaning apparatus 10 of the present invention and “B”, “C”, “D” and “E” refer to the conventional cleaning apparatus. The amounts of the residual water on the wafer (W) in table 1 are expressed in a relative magnitude, so they can be compared with each other. For the evaluation, a wafer (W) with patterns of a high aspect ratio was used.

TABLE 1

| | A | B | C | D | E |
|---|---|---|---|---|---|
| Amount of Residual Water | 5.1 | 12.3 | 10.3 | 26.4 | 21.0 |
| (in relative magnitude) | | | | | |

“B” and “C” apparatuses in Table 1 are the multi-wafer drying apparatus wherein the wafers are placed vertically during the cleaning process. However, the amount of the residual water from the cleaning apparatus 10 of present invention is less than a half of the apparatus B or C, even though the processing wafer of the wafer (W) upwardly faces in the cleaning apparatus 10 of the present invention.

In the embodiments of the present invention described as above, the cleaning apparatus 10 having the chemical supplying nozzle and the rinsing nozzle 300 is described, and the chemical cleaning process and the rinsing process as well as the drying process are carried out by the cleaning apparatus 10 of the present invention. However, the cleaning apparatus 10 of the present invention may be configured such that only the rinsing process and the drying process are carried out or only the drying process is carried out by the cleaning apparatus 10 of the present invention.

According to the above, the drying process is carried out while the processing chamber is in the organic solvent atmosphere, and thus the surface tension of the deionized water on the wafer may be greatly reduced, thereby easily removing the deionized water from the wafer.

Also, since the organic solvent is substantially simultaneously supplied to the entire surface of the wafer, the cleaning apparatus may prevent formation of the water spots.

Further, the concentration of the organic solvent may be maintained at a high level on the entire surface of the wafer since the organic solvent is directly supplied to the entire surface of the wafer. In addition, the wafer is heated by the heater, so that the deionized water in the fine patterns of the wafer may be effectively removed.

Moreover, the organic solvent atmosphere in the container, the concentration of the organic solvent on the entire surface of the wafer and the temperature of the wafer may be controlled using the controller, thereby enhancing the drying efficiency and reducing the process time required to dry the wafer.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

What is claimed is:

1. A cleaning apparatus comprising:
a process chamber defining a work space;
a supporter apparatus for rotating a wafer, the supporter apparatus being located in the work space and the wafer being mountable on the supporter apparatus such that a processing surface of the wafer is upwardly facing;
an organic solvent supplying nozzle for supplying an organic solvent into the work space to the processing surface of the wafer mounted on the supporter apparatus; and
a dry gas supplying nozzle for supplying an organic solvent vapor into the work space and forming an organic solvent atmosphere therein.

2. The cleaning apparatus of claim 1, wherein the organic solvent supplying nozzle comprises a total region supplying nozzle for supplying the organic solvent substantially to the total processing surface of the wafer extending from a center region to a peripheral region.

3. The cleaning apparatus of claim 2, wherein the total region supplying nozzle comprises a slit or a plurality of holes for spraying the organic solvent.

4. The cleaning apparatus of claim 2, wherein the organic solvent supplying nozzle comprises a center region supplying nozzle for supplying the organic solvent only to the center region of the wafer.

5. The cleaning apparatus of claim 1, wherein the process chamber comprises:
a container in which the supporter apparatus is located, the container having an opening at an upper portion thereof;
a lid for receiving the dry gas supplying nozzle and for opening or closing the opening of the container; and
a porous plate, positioned between the lid and the container, for distributing the dry gas supplied from the dry gas supplying nozzle into the container.

6. The cleaning apparatus of claim 1, further comprising a heater for heating the wafer mounted on the supporter apparatus.

7. The cleaning apparatus of claim 6, wherein the heater is a lamp that is located outside the process chamber.

8. The cleaning apparatus of claim 5, further comprising a lamp for heating the wafer mounted on the supporter apparatus, and
wherein the lid comprises:
a lower plate into which the dry gas supplying nozzle is installed; and
an upper plate disposed on the lower plate to receive the lamp therein.

9. The cleaning apparatus of claim 7, wherein the lamp has a ring-shape or a rod-shape.

10. The cleaning apparatus of claim 6, wherein the heater comprises at least one lamp located outside the container.

11. The cleaning apparatus of claim 6, further comprising a controller for controlling an amount of the organic solvent supplied from the organic solvent supplying nozzle such that a volume concentration of the organic solvent in a mixture of the organic solvent and cleaning chemicals on the processing surface of the wafer is greater than a volume concentration of the organic solvent in an azeotropic mixture, the mixture being at a temperature above the boiling point of the mixture.

12. The cleaning apparatus of claim 1, wherein the dry gas supplying nozzle is connected to a vapor supplier for supplying the organic solvent in a vapor state and to a gas supplier for supplying an inert gas.

13. The cleaning apparatus of claim 1, further comprising a rinsing nozzle mounted on the supporter apparatus for supplying a rinsing liquid onto the processing surface of the wafer.

14. The cleaning apparatus of claim 1, wherein the organic solvent comprises an isopropyl alcohol.

15. A cleaning apparatus comprising:
a process chamber defining a work space;
a supporter apparatus for rotating a wafer, the supporter apparatus being located in work space and the wafer being mountable on the supporter apparatus such that a processing surface of the wafer is upwardly facing; and
a total region supplying nozzle for supplying an organic solvent to a total processing surface of the wafer extending from a center region to a peripheral region.

16. The cleaning apparatus of claim 15, further comprising:
a heater for heating the wafer mounted on the supporter apparatus; and
a controller for controlling an amount of the organic solvent provided from an organic solvent supplying nozzle such that a volume concentration of the organic solvent in the mixture of the organic solvent and cleaning chemicals on the processing surface of the wafer is greater than a volume concentration of the organic solvent in an azeotropic mixture, the mixture being at a temperature above a boiling point of the mixture.

17. A cleaning method comprising:
providing a processing chamber defining a work space;
loading a wafer on a supporter apparatus located in the work space such that a processing surface of the wafer is upwardly facing;
introducing an organic solvent in a vapor state into the process chamber forming a drying atmosphere in the work space; and
directing the organic solvent vapor onto the processing surface of the wafer while substantially simultaneously rotating the wafer.

18. The cleaning method of claim 17, wherein the providing of the organic solvent onto the processing surface of the wafer comprises providing the organic solvent substantially simultaneously to a total processing surface of the wafer from a center region to a peripheral region.

19. The cleaning method of claim 18, wherein the providing of the organic solvent directly onto the processing surface of the wafer further comprises providing the organic solvent only to the center region of the wafer.

20. The cleaning method of claim 17, further comprising heating the wafer, wherein the organic solvent is provided onto the wafer surface from the organic solvent supplying nozzle such that a volume concentration in a mixture of the organic solvent and cleaning chemicals on the processing surface of the wafer is larger than a volume concentration of the organic solvent in an azeotropic mixture, the mixture being heated above the boiling point of the mixture.

21. The cleaning method of claim 17, further comprising, prior to providing the organic solvent into the work space for the drying atmosphere, supplying an inert gas into the work space to remove oxygen in the process chamber.

22. The cleaning method of claim 17, further comprising, prior to providing the organic solvent into the work space for the drying atmosphere, supplying an inert gas and an alcohol vapor into the work space to remove oxygen in the process chamber.

23. The cleaning method of claim 17, further comprising providing a heated inert gas onto the processing surface of the wafer to remove residual organic solvent on the wafer.

24. The cleaning method of claim 17, wherein the organic solvent comprises an isopropyl alcohol.
